(19) United States
(12) Patent Application Publication
(10) Pub. No.: US 2021/0271111 A1
(43) Pub. Date: Sep. 2, 2021

(54) Attachable reading glasses

(71) Applicant: Byron Calvin, Phoenix, AZ (US)

(72) Inventor: Byron Calvin, Phoenix, AZ (US)

(21) Appl. No.: 16/873,835

(22) Filed: Jul. 22, 2020

Related U.S. Application Data
(60) Provisional application No. 63/100,199, filed on Mar. 2, 2020.

(51) Int. Cl. G02C 7/08; G02C 9/04; G02C 7/06; G02B 1/04

(52) U.S. Cl. CPC G02C 7/086; G02B 1/041; G02C 7/061; G02C 9/04

(57) ABSTRACT

The present invention is attachable lenses to provide ability to increase capacity to read or focus on otherwise unseen details of objects, the attachable lenses provide magnification and the ability to have reading glasses on otherwise non magnified lenses as in safety glasses or sunglasses. The attachable lenses of the present invention provide a dual-use eyeglasses, a pair of glasses made for far sight and the attachable lenses applied to said glasses for close reading. The attachable lenses disclosed in the invention are capable of being manufactured in glass or hard plastic lenses of varying magnification strength which are attached to the non-magnified lenses of various types of glasses or spectacles by means of adhesion, either liquid adhesion or attached adhesive tape, both the liquid adhesive or adhesive tape being optically transparent to allow amplified vision.

### CROSS-REFERENCE TO RELATED APPLICATIONS

Incorporated by reference is Provisional Patent 63/100,199 filed by patent applicant Byron Calvin on Mar. 2, 2020, titled “Attachable Reading Glasses”.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

“Not Applicable”

### STATEMENT REGARDING PRIOR DISCLOSURES BY THE INVENTOR OR A JOINT INVENTOR

Incorporated by reference is Provisional Patent 63/100,199 filed by patent applicant Byron Calvin on Mar. 2, 2020, titled “Attachable Reading Glasses”.

### BACKGROUND OF THE INVENTION

### (1) Field of the Invention

The field of this invention is glasses, also known as eyeglasses or spectacles, are vision aids, consisting of glass or hard plastic lenses mounted in a frame that holds them in front of a person's eyes, typically utilizing a bridge over the nose and arms which rest over the ears.

Glasses are typically used for vision correction, such as with reading glasses and glasses used for nearsightedness.

Safety glasses provide eye protection against flying debris for construction workers or lab technicians; these glasses may have protection for the sides of the eyes as well as in the lenses. Some types of safety glasses are used to protect against visible and near visible light or radiation. Glasses are worn for eye protection in some sports.

Sunglasses allow for better vision in bright daylight and may protect one's eyes against damage from excessive levels of ultraviolet light. Typical sunglasses lenses are tinted for protection against bright light or polarized to remove glare; Photochromatic glasses are clear in dark or indoor conditions but turn into sunglasses when they come in contact with ultraviolet light. Most over the counter sunglasses do not have corrective power in the lenses; however, special prescription sunglasses can be made.

### (2) Description of Related Art Including Information Disclosed Under 37 CFR 1.97

Related art is in the field of corrective lenses which are used to correct refractive errors by bending the light entering the eye in order to alleviate the effects of conditions such as nearsightedness (myopia), farsightedness (hypermetropia) or astigmatism.

### SUMMARY OF THE INVENTION

The present invention is attachable lenses to provide ability to increase capacity to read or focus on otherwise unseen details of objects, the attachable lenses provide magnification and the ability to have reading glasses on otherwise non magnified lenses as in safety glasses or sunglasses. The attachable lenses of the present invention provide a dual-use eyeglass, a pair of glasses made for far sight and the attachable lenses applied to said glasses for close reading. The attachable lenses of the present disclosure provide for varying strength lenses for the left eye and the right eye, thereby creating custom reading glasses attachable to regular eyeglasses. The attachable lenses disclosed in the invention are capable of being manufactured in glass or hard plastic lenses which are attached to the non-magnified lenses of various types of glasses or spectacles by means of adhesion, either liquid adhesion or double-sided adhesive tape, both the liquid adhesive or adhesive tape being optically transparent to allow amplified vision.

### BRIEF DESCRIPTION OF THE DRAWINGS

FIG. 1 is a front view of a pair of rectangular glasses 30 with frame 25 and attachable square attachable lenses 7.

FIG. 2 is a front view of a pair of rectangular glasses 30 with frame 25 and attachable circular attachable lenses 8.

FIG. 3 is a front view of a pair of safety glasses 10 with frame 5 and attachable square attachable lenses 7.

FIG. 4 is a front view of a pair of circular glasses 20 with frame 15 and attachable square lenses 7.

FIG. 5 is a front view of a pair of circular glasses 20 with frame 15 and circular attachable lenses 8.

FIG. 6 is a front view of a pair of semi rectangular glasses 40 with frame 35 and square attachable lenses 7.

FIG. 7 is a front view of a pair of semi rectangular glasses 40 with frame 35 and circular attachable lenses 8.

FIG. 8 is a front view of a pair of sunglasses 50 with frame 45 and square attachable lenses 7.

FIG. 9 is a front view of a pair of sunglasses 50 with frame 45 and circular attachable lenses 8.

### DESCRIPTION OF THE INVENTION

Incorporated by reference is Provisional Patent 63/100,199 filed by patent applicant Byron Calvin on Mar. 2, 2020, titled “Attachable Reading Glasses”.

The present invention is attachable lenses to provide ability to increase capacity to read or focus on otherwise unseen details of objects, the attachable lenses provide magnification and the ability to have reading glasses on otherwise non magnified lenses as in safety glasses or sunglasses. The attachable lenses disclosed in the invention are capable of being manufactured in glass or plastic lenses which are attached to the non-magnified lenses of various types of glasses or spectacles by means of adhesion, either liquid adhesion or attached adhesive tape, both the liquid adhesive or adhesive tape being optically transparent to allow amplified vision. The various types of eyeglasses that can benefit the user by the attachable reading glasses will be discussed further.

The ability of one's eyes to accommodate their focus to near and distant focus alters over time. A common condition in people over forty years old is presbyopia, which is caused by the eye's crystalline lens losing elasticity, progressively reducing the ability of the lens to accommodate or focus on objects close to the eye. Corrective lenses bring the image back into focus on the retina. The most common type of corrective lens is single vision which has a uniform refractive index.

### Reading Glasses

Reading glasses provide a separate set of glasses for focusing on close-by objects. Reading glasses are available without prescription from drugstores, and offer a cheap, practical solution, though these have a pair of simple lenses of equal power. The attachable lenses of the present disclosure allow for attachment of different magnification power for each eye, as is common that the eyes of a person can need different magnification for each eye. For an attachable lens as disclosed herein provides the user flexibility and convenience for attaching reading glasses to other type of glasses normally not magnified, such as safety glasses.

### Safety Glasses

Safety glasses are worn to protect the eyes in various situations. They are made with break-proof plastic lenses to protect the eye from flying debris or other matter. Construction workers, factory workers, machinists and lab technicians are often required to wear safety glasses to shield the eyes from flying debris or hazardous splatters such as blood or chemicals. As of 2017, dentists and surgeons in Canada and other countries are required to wear safety glasses to protect against infection from patient's blood or other body fluids. There are also safety glasses for welding, which are styled like wraparound sunglasses, but with much darker lenses, for use in welding where a full-sized welding helmet is inconvenient or uncomfortable. These are often called “flash goggles” because they provide protection from welding flash. Nylon frames are usually used for protective eye wear for sports because of their lightweight and flexible properties. Unlike most regular glasses, safety glasses often include protection beside the eyes as well as in front of the eyes. The attachable reading glasses of this disclosure provide magnification to safety glasses to focus on detail and for reading safety labels, etc.

### Sunglasses

Sunglasses provide more comfort and protection against bright light and often against ultraviolet (UV) light. To properly protect the eyes from the dangers of UV light, sunglasses should have a UV blocker to provide good coverage against the entire light spectrum that poses a danger. The dark tint of the lenses in a pair of sunglasses blocks the transmission of light through the lens. Normally sunglasses lenses are not magnified, thereby can be made capable of magnified lenses through the attachable lenses of the present disclosure.

Sunglasses may be worn for aesthetic purposes, or simply to hide the eyes. Sunglasses may also have corrective lenses, which requires a prescription. Clip-on sunglasses or sunglass clips can be attached to another pair of glasses. Some wrap-around sunglasses are large enough to be worn over top of another pair of glasses. Many people opt to wear contact lenses to correct their vision so that standard sunglasses can be used. The attachable reading glasses of the present disclosure is a convenient alternative.

### Anti-Glare Protection Glasses

Anti-glare protection glasses, or blue-light glasses, can reduce the reflection of light that enters our eyes. The lenses are given an anti-glare coating to prevent reflections of light under different lighting conditions. By reducing the amount of glare on your eyes, vision can be improved. The anti-glare glasses can be improved to also be reading glasses by the attachable lenses of the present disclosure.

### Attachable Lens Shape

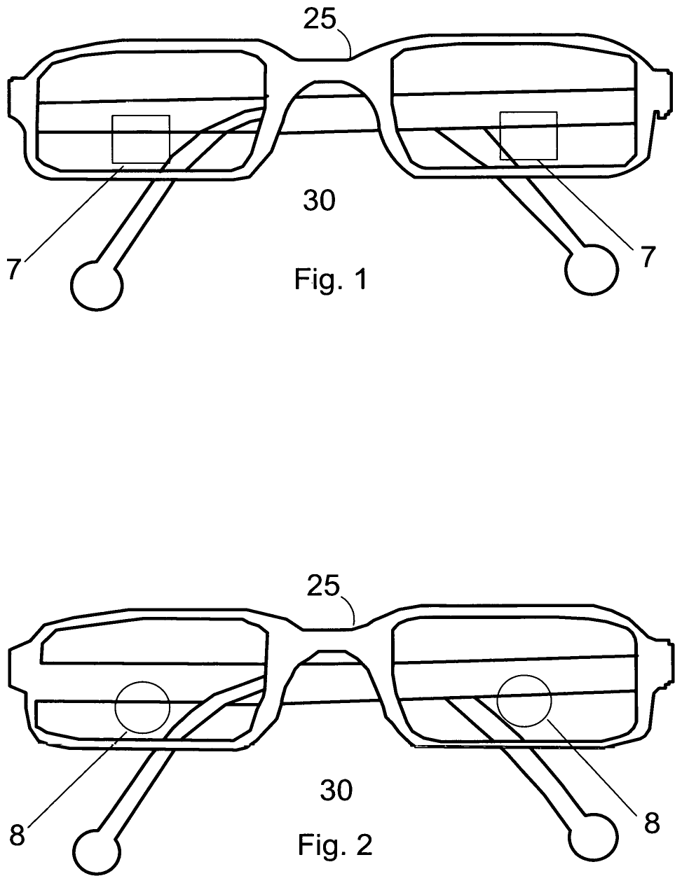

The attachable lenses of the present disclosure can be produced in many different shapes from a circular lens called a lens blank. Lens blanks are cut to fit the shape of the frame or the preference of the user. Frame styles vary and fashion trends change over time, resulting in a multitude of lens shapes. For lower power lenses, there are few restrictions in material and shape. Glass or plastic are used for these lenses. Higher power lenses are also made of these materials, but their shape is normally smaller to prevent peripheral vision distortion. As described in the various FIGS. 1 through 9, square and circular lenses are presented, although this is not meant to be limiting.

### Liquid Optically Clear Adhesive

The attachable lenses of the present disclosure can be adhered to the various types of eyeglasses discussed previously and the eyeglasses presented in FIGS. 1 through 9 by liquid optically clear adhesive known as (LOCA) in common terminology. This adhesive has superior optical qualities allowing for minimal distortion on application to attachable glass lenses or a combination of plastic and glass as seen in the various Figures.

LOCA is an optically clear adhesive and can be applied in liquid form or on optically clear adhesive tape known commonly as OCA tape. Both methods of application will bind the attachable lenses of the present invention to either plastic or glass lenses of common eyeglasses.

Turning now to the various FIGS. 1 through 9:

FIG. 1 is a front view of a pair of rectangular glasses 30 with frame 25 and square attachable lenses 7, said attachable lenses 7 are magnified to allow the user to focus on lettering or close detail of an object.

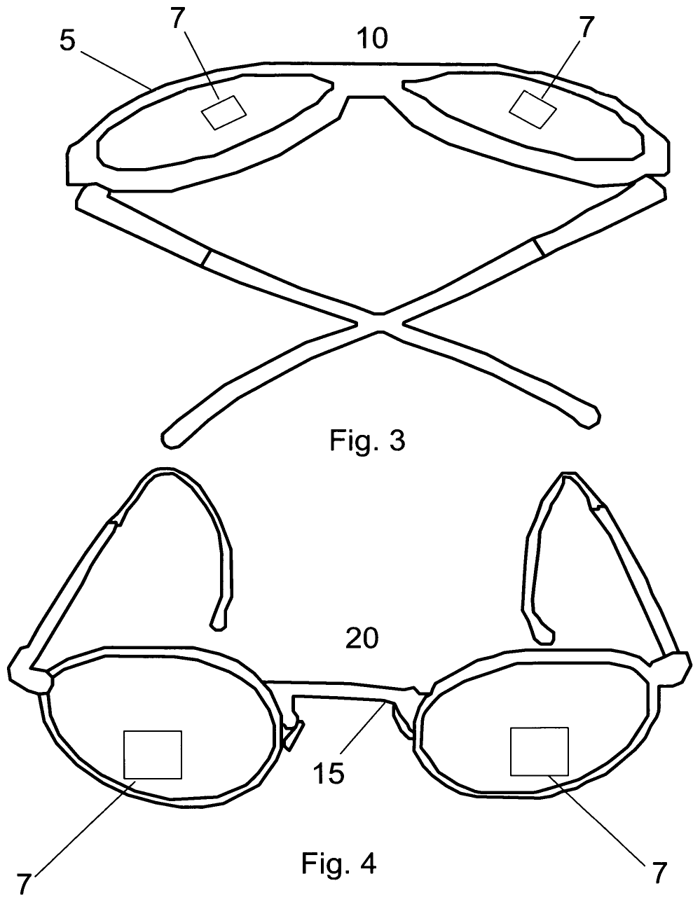

FIG. 2 is a front view of a pair of rectangular glasses 30 with frame 25 and attachable circular attachable lenses 8, said circular lenses are magnified for reading or focusing on close detail of an object, rectangular glasses are of a magnification to see far and the circular lenses 8 are magnified for close objects.

FIG. 3 is a front view of a pair of safety glasses 10 with frame 5 and attachable square lenses 7, said lenses 7 are magnified for reading or to focus on detail of an object.

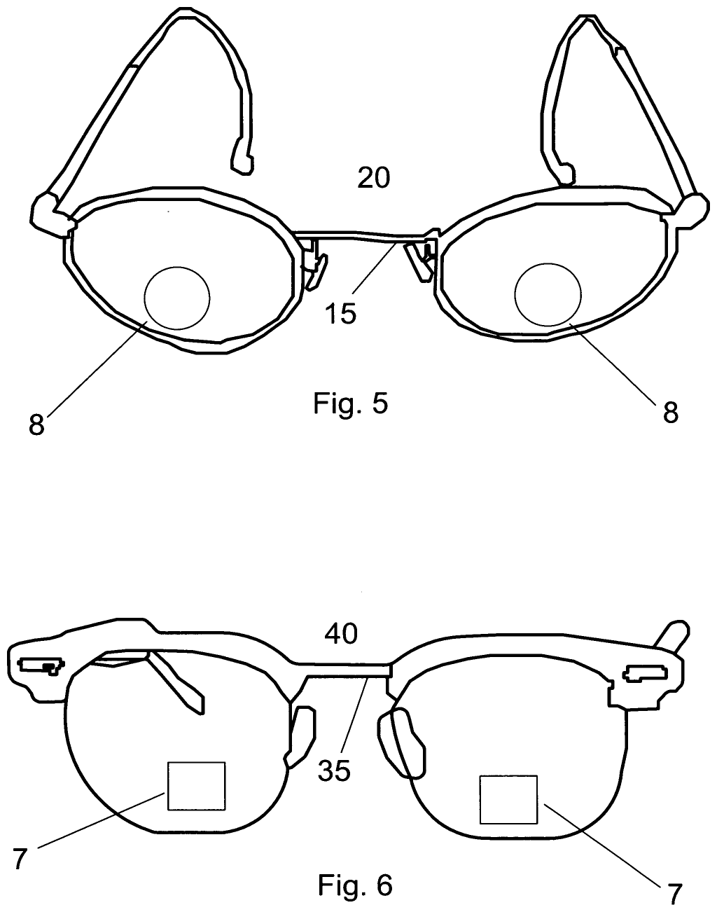

FIG. 4 is a front view of a pair of circular glasses 20 with frame 15 and attachable square lenses 7, said lenses 7 are magnified for reading or to focus on detail of an object.

FIG. 5 is a front view of a pair of circular glasses 20 with frame 15 and circular attachable lenses 8, said lenses 8 are magnified for reading or to focus on detail of an object.

FIG. 6 is a front view of a pair of semi rectangular glasses 40 with frame 35 and square attachable lenses 7, said lenses 7 are magnified for reading or to focus on detail of an object.

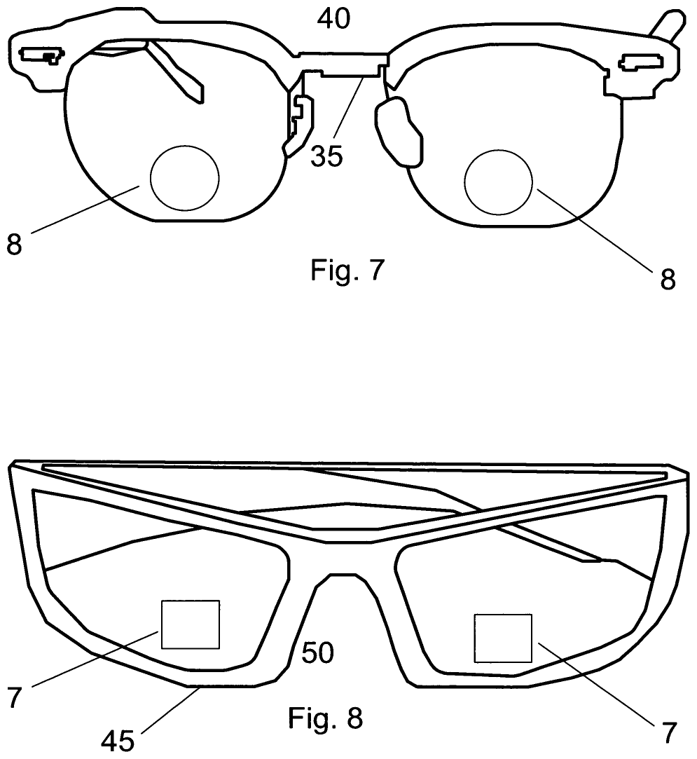

FIG. 7 is a front view of a pair of semi rectangular glasses 40 with frame 35 and circular attachable lenses 8, said attachable lenses 8 are magnified for reading or to focus on detail of an object.

FIG. 8 is a front view of a pair of sunglasses 50 with frame 45 and square attachable lenses 7, said sunglasses 50 are tinted to protect against sunlight and ultraviolet light, said lenses 7 are magnified for reading or to focus on detail of an object.

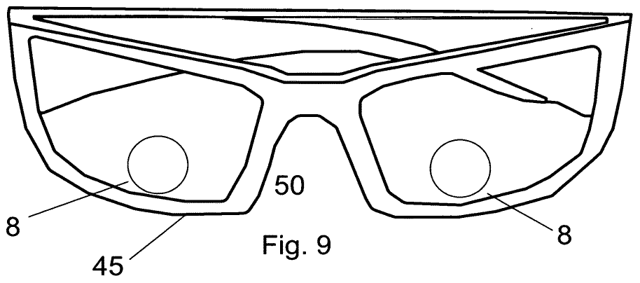

FIG. 9 is a front view of a pair of sunglasses 50 with frame 45 and circular attachable lenses 8, said lenses 8 are magnified for reading and sunglasses 50 are tinted to protect against daylight and ultraviolet rays.

Manufacture of lenses

The attachable lenses of the present disclosure are produced in optical laboratories or in full service optical outlets by working with “blanks” which are plastic lenses already formed to exact magnification with different curves ground into the front of the lens. Blanks with different curves are used for specific optical properties.

The plastic blanks received form optical laboratories are round pieces of plastic such as polycarbonate approximately 1.9 centimeters thick. For purpose of the attachable lenses disclosed herein, the thickness is narrower to allow for easier attachment of these lenses to the surface of an existing pair of eyeglasses.

The design of these blanks vary from square, oval, round or other shapes to fit on the surface of existing eyeglasses, the location of the attachable lenses is in the lower center area of the existing eyeglass lenses to permit magnification at the location of a person's pupil.

The attachable lenses can be treated for tinting, the coatings are added by dipping the lenses into heated metal bins filled with a tint. The treatments and tints available include various sunglass tints and colors, ultraviolet light tints, durability and impact resistant treatments and scratch resistant treatments. Among the latest advances in tints is the light sensitive tint, which combines the advantages of regular clear lenses with the protection of sunglasses. These lenses adjust to the amount of sunlight being radiated, thus providing sun protection when needed.

Various grades of plastic are used for eye wear, but the most popular is the “feather weight”, an impact resistant polycarbonate plastic. This type of plastic lens is more durable and 30 percent thinner and lighter than regular plastic lenses. Other lens types include the standard “CR-39” trade name plastic lens, CR 39 is a monomer plastic, and the “high index” plastic lens which is 20 percent thinner and lighter than ordinary plastic lenses. These materials are used for the attachable lenses of the present disclosure.

### Manufacturing Process

The attachable lenses of the present disclosure are produced in optical laboratories by the following process:
The optical laboratory technician inputs the magnification for a pair of plastic lenses in a laboratory computer programmed to provide a printout of the information required to produce this magnification on plastic lens “blanks”.
Based on the computer printout, the technician selects the appropriate plastic lens blanks.
The selected plastic blanks have a curve already ground into the front of the lens for the required magnification.
The technician places the lenses in a lens meter, an instrument used to locate and mark the “optical center”, the point that should be centered over the customer's pupil of the lens blanks.

Various grades of plastic are used for eye lenses, the most popular is nicknamed “Feather-weight” an impact resistant polycarbonate plastic. This type of plastic lens is more durable and 30 percent thinner and lighter than regular plastic lenses. This plastic material is specified for manufacture of the attachable lenses of the present disclosure.

### Quality Control

Plastic eyeglass lenses of the present disclosure meet the quality control standards of the American National Standards Institute and the Food and Drug Administration (FDA). The optical laboratories producing the plastic lenses also belong to the National Optical Association which requires prescribed guidelines regarding quality.

As the plastic lenses of the present disclosure are of reduced size as compared to lenses for regular eyeglasses, the procedures for manufacture of these lenses is unique and controlled by computers which are programmed to print out the manufacturing parameters for either circular or rectangular lenses of differing magnification parameters for reading strengths, i.e. +2.0, +3.0 etc.

Although corrective lenses as disclosed can be produced in many different profiles, the most conducive to attachment on the lenses of regular eyeglasses, regular sunglasses, regular safety glasses are the plano-convex type of lenses which have a curvature in front of the lens only, the back is straight for better adherence to an existing eyeglass lens. The curvature in front of the plano-convex lens is adjusted for the differing reading strength of the attachable lenses of this disclosure.

Although a plano-convex lens is preferred, this is not limiting as other optical profiles can be used for the attachable lenses. The convenient feature of the attachable lenses is the attachment to regular glasses with corrective lenses for distance, the attachable lens will now allow the user to also focus for close reading or for close activities.

Optical Quality

Of all the properties of a lens material, the one that most closely relates to its optical performance is its dispersion, which is specified by what is known as an Abbe number. Higher Abbe numbers mean a better lens material, and lower Abbe numbers result in the presence of chromatic aberration which are color fringes above or below or to the left or right of a high contrast object. This occurs in larger lens and stronger prescriptions in excess of +4.00 D. The lenses of the present disclosure are smaller than regular eyeglass lenses which will avoid chromatic aberrations. The quality control of the attachable lenses of the present disclosure targets the higher Abbe numbers in lens manufacture.

A further note on adhesion is to coat optical translucent adhesive on the back of attachable vision magnification lenses and cover the lenses with a flexible plastic membrane which is removed to allow adhesion when said lenses are attached to regular eyeglasses.

What is claimed is:

1. Attachable reading glasses comprising regular eyeglasses, attachable vision magnification lenses, and adhesive, wherein the attachable vision magnification lenses are coated in back of the lens with an optical translucent adhesive to attach the attachable magnified lenses on the surface of the regular eyeglasses lenses and create reading glasses.

2. The attachable reading glasses of claim 1 wherein regular glasses comprise eyeglasses for distance focusing.

3. The attachable reading glasses of claim 1 wherein the attachable vision magnification lenses comprise lenses made of polycarbonate plastic.

4. The attachable reading glasses of claim 3 wherein the attachable vision magnification lenses are of a reduced size to fit on the regular eyeglasses lenses on the lower center of the regular eyeglasses lenses allowing the user to have use of distance focusing and close up vision magnification from the attachable vision magnification lenses.

5. The attachable reading glasses of claim 4 wherein said attachable vision magnification lenses comprise lenses of varying vision magnification strength to meet the magnification requirements of the left eye and the right eye.

6. The attachable reading glasses of claim 1 wherein said optical translucent adhesive comprises an optically clear adhesive and can be applied in liquid form or on optically clear adhesive tape.

7. The attachable reading glasses of claim 6 wherein said optical translucent adhesive is applied to the back of said attachable vision magnification lenses and covered with a flexible plastic membrane, said plastic membrane is detached to allow placement of the attachable vision magnification lenses onto the regular eyeglass lens, said optical translucent adhesive will adhere the vision magnification lens to the lens of the regular eyeglass.

8. An attachable reading glasses method comprising regular eyeglasses, attachable vision magnification lenses, and adhesive, wherein the attachable vision magnification lenses are coated in back of the lens with an optical translucent adhesive to attach the attachable magnified lenses on the surface of the regular eyeglasses lenses and create reading glasses, said method comprising the following steps:
providing a pair of regular eyeglasses;
providing a pair of said attachable vision magnification lenses;
providing an adhesive which is optically translucent;
coating said optically translucent adhesive to the back of said attachable magnification lenses; and
adhering said attachable magnification lenses to the surface of the lenses of said regular eyeglass lenses.

9. The attachable reading glasses method of claim 8 wherein regular eyeglasses comprises sunglasses, safety glasses, glasses with distance vision magnification, and corrective vision glasses.

10. The attachable reading glasses method of claim 8 wherein said attachable vision magnification lenses are of reduced size to fit in the lower center of the lenses of said regular eyeglasses.

11. The attachable reading glasses method of claim 10 wherein said attachable vision magnification lenses are produced in various vision magnification strengths.

12. The attachable reading glasses method of claim 11 wherein said attachable vision magnification lenses are attached to the regular eyeglasses, said vision magnification lenses providing a magnification strength complying to the magnification needs of the left eye and right eye.

13. The attachable reading glasses method of claim 11 wherein said attachable vision magnification lenses are produced in various designs comprising round lenses, rectangular lenses, and square lenses.

14. The attachable reading glasses method of claim 8 wherein said optical translucent adhesive is coated on the back of said attachable vision magnification lenses and covered with a flexible plastic membrane which is removed to allow adhesion when said lenses are attached to regular eyeglasses.

15. The attachable reading glasses method of claim 14 wherein said flexible plastic membrane is removed and said vision magnification lenses are placed on front center and bottom of said regular eyeglasses lenses, the optical translucent adhesive will then adhere the vision magnification lenses onto the regular eyeglass lenses.

16. The attachable reading glasses method of claim 8 wherein said vision magnification lenses are adhered to regular eyeglasses with optically translucent double-sided adhesive tape.

17. Attachable reading glasses comprising regular eyeglasses, attachable vision magnification lenses, and adhesive, wherein the attachable vision magnification lenses are coated in back of the lens with an optical translucent adhesive or optically translucent double sided adhesive tape to attach the attachable magnified lenses on the surface of the regular eyeglasses lenses, said attachable magnified lenses provided in varying magnification strength to provide for the required magnification strength for the left eye and the right eye and create custom reading glasses.
